(19) United States
(12) Patent Application Publication
(10) Pub. No.: US 2007/0180187 A1
(43) Pub. Date: Aug. 2, 2007

(54) Reducing power consumption by disabling refresh of unused portions of DRAM during periods of device inactivity

(76) Inventors: Keith Olson, San Diego, CA (US); Alex Kuang-Hsuan Tu, San Diego, CA (US)

Correspondence Address: QUALCOMM INCORPORATED, 5775 MOREHOUSE DR., SAN DIEGO, CA, 92121, US

(21) Appl. No.: 11/345,975

(22) Filed: Feb. 1, 2006

(51) Int. Cl. G06F 12/00

(52) U.S. Cl. 711/106; 711/203

(57) ABSTRACT

Power consumption of a mobile communication device is reduced by disabling refreshing of unused portions of DRAM. DRAM includes multiple separately refreshable memory refresh ranges (MRRs). A memory refresh manager (MRM) within the device's operating system identifies ranges of virtual memory that will not be used during subsequent sleep mode operation. The MRM remaps virtual to physical memory space to conglomerate the physical memory pages (associated with virtual memory that will not be used) in certain MRRs such that the contents of entire MRRs need not be maintained in sleep mode. Information in any remapped physical page that needs to be maintained during sleep mode is copied so that it resides at the same virtual address after the remapping as before. Other software operates in virtual memory space and is not affected by the remapping. Refreshing of the certain MRRs is then disabled for sleep mode, thereby reducing power consumption.

### BACKGROUND

1. Field

The disclosed embodiments relate to disabling the refreshing of portions of dynamic random access memory (DRAM) to conserve power in a mobile communication device.

2. Background Information

How long a mobile communication device (such as a cellular telephone) can operate between battery recharging operations is an important to users. Accordingly, reducing power consumption of mobile communication devices is desired. Complicating matters, a cellular telephone today may have many more functions than just the cellular telephone function. The cellular telephone is actually becoming somewhat of a general purpose hardware platform upon which an operating system executes. Each of the various functions of the cellular telephone platform generally has its own application layer program. Executing some of these application layer programs may involve using a large amount of memory and processing resources. For example, the cellular telephone may have a digital camera functionality in addition to its cellular telephone communication functionality. When the cellular telephone is being used as a digital camera, a large amount of memory may be used to capture, process and store megapixel digital images. A large amount of memory is therefore now provided on contemporary cellular telephones. Due to the large amount of memory provided, the memory is often dynamic random access memory (DRAM). DRAM requires refreshing and this refreshing consumes power. A solution that reduces amount of power consumed performing DRAM refresh is desired so that the mobile communication device can operate for longer periods between battery rechargings.

### SUMMARY INFORMATION

The power consumption of a mobile communication device (for example, a cellular telephone) is reduced by disabling the refreshing of unused portions of the mobile communication device's DRAM. In one exemplary mobile communication device, the DRAM includes multiple memory refresh ranges (MRRs). Refreshing of each MRR can be enabled and disabled independently of the refreshing of each other MRR.

A novel memory refresh manager (MRM) is provided within the operating system of the mobile communication device. The MRM identifies ranges of virtual memory space that do not need to be maintained during subsequent sleep mode operation. In one example, a heap manager of the operating system provides a list of ranges of heap virtual memory that will not be used by the heap during sleep mode operation. This list is provided to the MRM. In another example, a task manager of the operating system provides a list of ranges of stack virtual memory that will not be used by stacks during sleep mode operation. This list is also provided to the MRM. The MRM uses the information in the lists, rearranges the data in physical memory space, and remaps virtual to physical memory space to conglomerate the physical memory pages (associated with ranges of virtual memory that will not need to be maintained during sleep mode) into a set of MRRs. The remapping is such that no portion of any one of the MRRs of the set is a portion that must be maintained in sleep mode. In one example, the MRM selects the MRRs that will be in the set so as to maximize the sum MRR memory space of all the MRRs in the set. By maximizing this MRR memory space, the amount of DRAM that is not refreshed during subsequent sleep mode operation is maximized. By maximizing the amount of DRAM that is not refreshed, the amount of power savings is also maximized.

Information in any remapped physical memory page that needs to be refreshed during sleep mode operation is copied to a new physical memory page so that it resides at the same virtual address after the remapping as before. This copying is done by the MRM before the remapping operation described above. Because other software (other than the MRM) operating on the mobile communication device operates in virtual memory space, operation of this other software is not affected by the remapping.

Once the copying and remapping has been carried out, then the MRM reconfigures the memory system of the mobile communication device to disable refreshing of the MRMs of the set. In one example, the MRM disables refreshing by writing appropriate control information into a memory controller of the memory system. The memory controller controls the refreshing of each MRR in DRAM in accordance with the control information. The mobile communication device then begins sleep mode operation. During sleep mode operation, none of the MRMs of the set is refreshed, thereby conserving the power that would otherwise be consumed where the set of MRRs refreshed during sleep mode. Other MRMs (other than the MRMs of the set) that contain information that must be maintained or that will be used during sleep mode are refreshed so that the software that is running during sleep mode works properly.

When the mobile communication device is to cease low power sleep mode operation and resume normal operational mode operation, the MRM reconfigures the memory system to enable refreshing of all MRMs. Once all MRMs of DRAM are being refreshed and are operational, then normal operational mode operation resumes.

Additional embodiments and details are described in the detailed description below. This summary does not purport to define the invention. The invention is defined by the claims.

### BRIEF DESCRIPTION OF THE DRAWINGS

FIG. 1 is a block diagram that illustrates selected functional components (software and hardware) of a mobile communication device 1 in accordance with one novel embodiment.

FIG. 2 is a diagram that illustrates heap memory space. A portion of heap memory space is allocated, and a portion is free.

FIG. 3A is a diagram that illustrates stack memory space. A portion of stack memory space is being used by stacks, and a portion is not being used by stacks.

FIG. 3B is a diagram of pseudocode that illustrates how nested procedure calls result in pushing items onto the stack of FIG. 3A.

FIG. 3C is a diagram that lists pushing and popping operations carried out when the pseudocode of FIG. 3B is executed.

FIG. 4A is a diagram that illustrates how a memory management unit (MMU) maps virtual memory addresses output by the CPU to physical memory addresses used by the memory system.

FIG. 4B is a table that illustrates a virtual to physical memory space translation.

FIG. 5 is a diagram that illustrates how DRAM memory space is sectioned up into multiple memory refresh regions (MRRs). Refreshing of each MRR can be enabled or disabled independently of the refreshing of the other MRRs.

FIG. 6 is a simplified flowchart of a first novel method. Refreshing of MRRs during sleep mode is disabled without MMU remapping of virtual to physical address space.

FIG. 7 is a memory space diagram for the first method of FIG. 6.

FIG. 8 is a simplified flowchart of a second novel method. MMU remapping of virtual to physical memory space is performed to conglomerate physical memory pages, the contents of which do not need to be maintained during subsequent sleep mode operation. The conglomerated physical memory pages are mapped so that they entirely occupy a set of MRRs. The mapping is performed so that the total amount of MRR memory space that need not be maintained during sleep mode is maximized or is substantially maximized. After the remapping, sleep mode operation occurs without the set of MRRs being refreshed, thereby reducing power consumption.

FIG. 9 is a memory space diagram for the second method of FIG. 8.

FIG. 10 is a simplified flowchart of a third method wherein refreshing of all MRMs is enabled prior to returning from sleep mode operation to normal operational mode operation.

### DETAILED DESCRIPTION

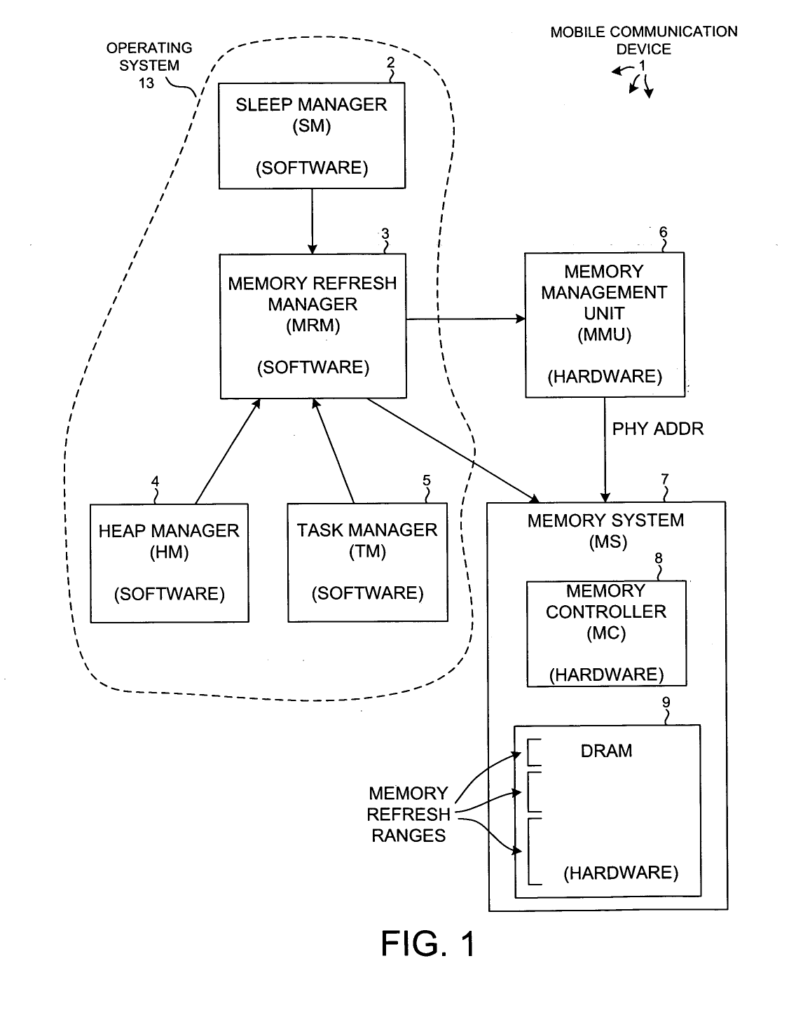

FIG. 1 is a block diagram that illustrates functional components of a mobile communication device 1 in accordance with one novel embodiment. Mobile communication device 1 includes software and hardware. The software includes an operating system 13 that in turn includes a sleep manager (SM) 2, a memory refresh manager (MRM) 3, a heap manager (HM) 4 and a task manager (TM) 5. The hardware includes a central processing unit (CPU), a memory management unit (MMU) 6 and a memory system 7. Memory system 7 includes a memory controller (MC) 8 and an amount of dynamic random access memory (DRAM) 9. Whereas the CPU, MMU and MC are integrated onto a single integrated circuit, the DRAM is realized as a discrete DRAM integrated circuit in order to take advantage of high volume production of such DRAM integrated circuits.

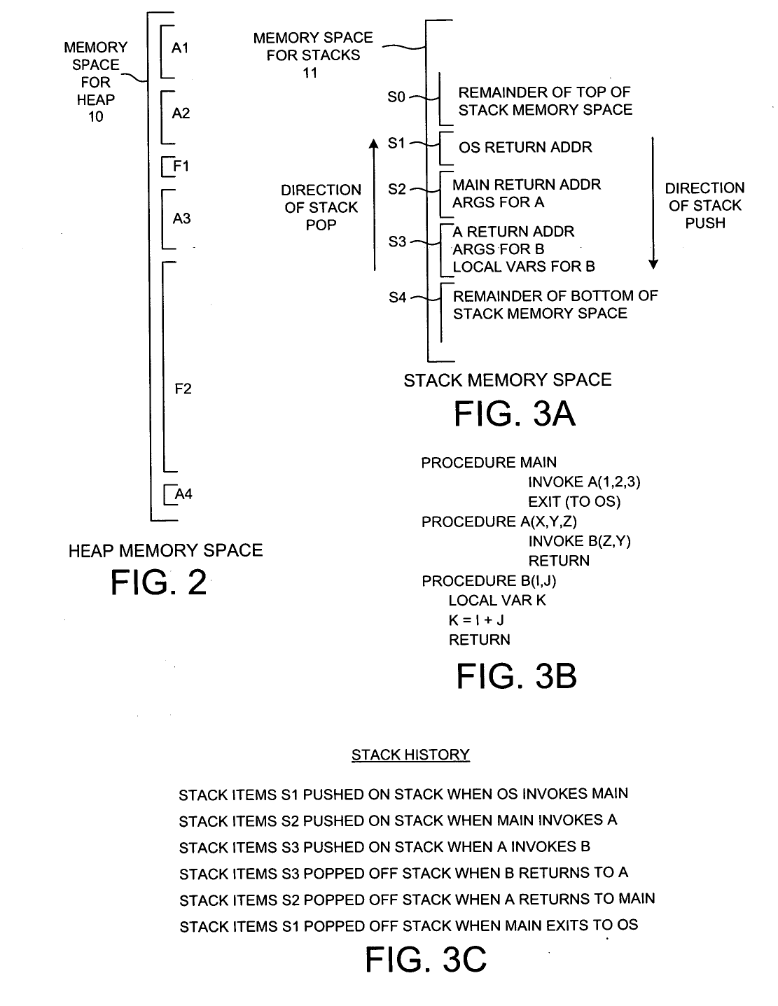

FIG. 2 is a diagram that illustrates a heap 10 of memory space that is managed by heap manager 4. The vertical dimension in the diagram represents the overall memory address space reserved for the heap and made available to the CPU of the mobile communication device 1. The memory space may represent space in various types of storage devices including, for example, DRAM 9, static random access memory (SRAM), non-volatile storage, and other types of data storage. In the example illustrated in FIG. 2, the heap 10 is sectioned up into six sections. The sections are denoted A1, A2, F1, A3, F2 and A4. The “A” in this notation indicates that the section has been “allocated” by heap manager 4 to a software entity (for example, an application program, a procedure or a task). The “F” in this notation indicates that the section of memory is “free”. Free means that the section of memory is not being used by any software. Heap manager 4 maintains an awareness of each of the sections of the memory space and whether each section has been “allocated” or is “free”. When an application program is launched, the application program will typically make a request to heap manager 4 for an amount of memory space. The heap manager 4 will respond by allocating one or more free sections of memory to the application program. When the application program no longer needs use of the sections of memory allocated to it, then the application program will typically make a request to free the memory to heap manager 4. Heap manager 4 responds and considers the section or sections of memory to be “free” and available for future allocation to other software entities. As indicated by the diagram, the sizes of the various sections of memory of heap 10 typically vary.

When mobile communication device 1 is in use, multiple different application programs may be executing simultaneously. These application programs may together require use of a large amount of memory. Accordingly, much of the heap may be allocated. Where DRAM is used to provide the heap memory space, the DRAM memory cells must be periodically refreshed so that the information stored in the DRAM memory cells is not lost. This refreshing involves charging capacitances in the DRAM memory cells, and therefore involves current flow and power consumption. The use of large amounts of DRAM by application programs when the mobile communication device 1 is in use therefore involves a significant amount of power being consumed just to refresh the DRAM.

Mobile communication device 1, however, also has a low power sleep mode. When mobile communication device 1 is operating in sleep mode, very few or no application layer programs are active. The mobile communication device 1 may be doing little more than monitoring communication traffic to determine whether a message is destined for the mobile communication device and to determine whether the mobile communication device should exit sleep mode and resume normal operation. When mobile communication device 1 is operating in the sleep mode, a great deal of the DRAM in the heap is “free” and is not in use. The free portion of DRAM heap memory need not be refreshed when it is not in use.

FIGS. 3A, 3B and 3C are diagrams that illustrate operation of a stack managed by task manager 2. The stack occupies a portion of memory space 11 reserved for stack usage. Stack memory space 11 is represented in FIG. 3A as a column of memory space extending downward. FIG. 3B illustrates a portion of pseudocode that includes a procedure “main”, a procedure “A”, and a procedure “B”. FIG. 3C illustrates a sequence of events that might take place when the code of FIG. 3B is executed. In the example illustrated, software is initially executing from some memory location. When the procedure “main” is invoked, the program counter of the CPU and the CPU's state is pushed onto the stack. The information pushed onto the stack is denoted S1 in FIG. 3A. Execution of procedure “main” begins. As illustrated in FIG. 3B, execution of procedure “main” reaches the “INVOKE A (1,2,3)” operation. Before process flow jumps to procedure A, the program counter and processor state is pushed onto the stack. This information pushed onto the stack is denoted S2 in FIG. 3A. Accordingly, as items are pushed onto the stack, the amount of stack memory space 11 that is used by the stack increases such that the stack grows downward in the direction of the illustration. Next, as illustrated in FIG. 3B, execution of procedure A reaches the “INVOKE B(X,Y,Z)” operation. Before processing jumps to procedure B, the program counter and processor state is pushed onto the stack. This information pushed onto the stack is denoted S3 in FIG. 3A. Accordingly, as execution of the software gets deeper and deeper into nested procedure calls, more and more information is pushed onto the stack. The amount of memory space 11 that is used increases. The amount of memory space 11 that is free decreases.

Next, execution of procedure B begins. When the RETURN at the end of procedure B is reached, then processing is to return to procedure A. To return to procedure A, the items S3 are popped off the stack and are used to restore the CPU's program counter and the CPU's state. The used portion of the memory space 11 therefore decreases. Processing returns to procedure A. When the RETURN at the end of procedure A is reached, then processing is to return to procedure “main”. To return to procedure “main”, the items S2 are popped off the stack and are used to restore program counter and processor state. The used portion of memory space 11 therefore decreases further. When the CPU is executing in the procedure “main”, the only items on the stack are the items S1. When the “EXIT (TO OS)” operation at the end of the procedure “main” is reached, then the items S1 are popped off the stack and are used to restore program counter and processor state.

When mobile communication device 1 is in use, software execution may be such that many items are pushed onto many different stacks. The amount of memory space 11 actively being used is large. In contrast, when mobile communication device 1 is in the low power sleep mode, very little software activity takes place. Few or no application layer programs are running and little of memory space 11 is being used by stacks. If the unused portion of memory space 11 is realized in DRAM, then that DRAM need not be refreshed because nothing is being stored in the unused portion of DRAM.

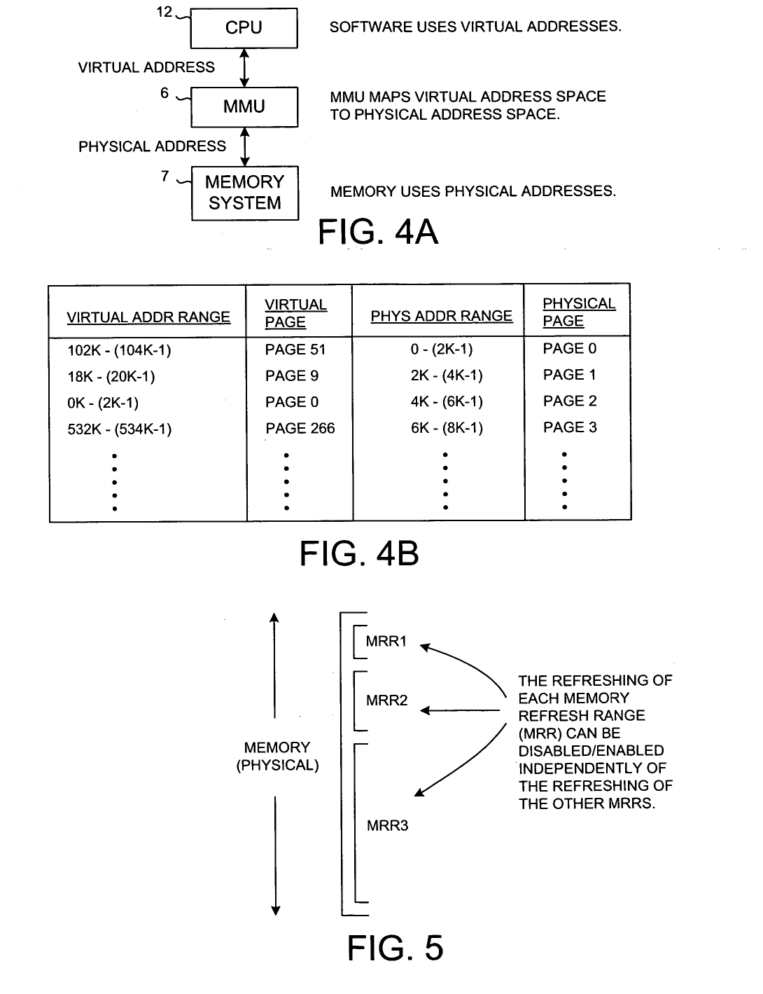

FIG. 4A is a simplified diagram that illustrates how the MMU 6 of mobile communication device 1 maps virtual memory address space to physical memory address space. The physical memory of memory system 7 is organized as a plurality of physical memory pages (MPs). In the present example, each physical MP contains 2 k memory locations. The software executing on the CPU operates in virtual memory space as if the addresses specified by the software were addresses in one continuous address space. Each 2 k address space (referred to here as a “virtual memory page”) of the virtual memory space is, however, mapped by MMU 6 to a corresponding one of the physical MPs.

FIG. 4B is a diagram of a table that sets forth one example of such a virtual memory space to physical memory space mapping. Virtual address range (102 k-(104 k−1)) is mapped to physical address range (0-(2 k−1)) and to physical memory page 0; virtual address range (18 k-(20 k−1)) is mapped to physical address range (2 k-(4 k−1)) and to physical memory page 1; and so forth down the rows of the table. Physical page size is dependent on the characteristics of the MMU and the physical memory used. The operating system of mobile communication device 1 can write to MMU 6 and change the virtual to physical mapping. By changing the mapping, the virtual address range that addresses a portion of stack memory 11 can be changed so that it is no longer mapped to a first page of physical memory but rather now is mapped to a second page of physical memory. If the contents of the portion of stack memory space 11 is copied from the first page to the second page, then when the software executes in virtual address space and accesses a memory location in the virtual address range, the same contents of stack memory space will be available to the software. Because the software operates in virtual address space, from the software's perspective the content of memory is identical before and after the remapping.

FIG. 5 is a diagram that illustrates an example of a plurality of memory refresh regions (MRRs) of the DRAM 9 of memory system 7. The vertical dimension in the diagram represents the physical address space occupied by DRAM 9. DRAM 9 includes three MRRs denoted MRR1, MRR2 and MRR3, respectively. Memory controller 8 controls the refreshing of the MRRs of the DRAM. Due to the construction of memory system 7, the refreshing of each MRR can be disabled or enabled independently of the refreshing of the other MRRs. In the illustrated example of FIG. 5, the sizes of each of the MRRs is different. To disable refreshing of an MRR, MRM 3 writes appropriate control information into memory controller (MC) 8. Memory controller 8 responds to the control information by stopping the refreshing of the designated MRR. Similarly, MRM 3 can write appropriate control information into memory controller 8 such that refreshing of a selected MRR is enabled. Memory controller 8 responds to the control information by initiating refreshing of the designated MRR.

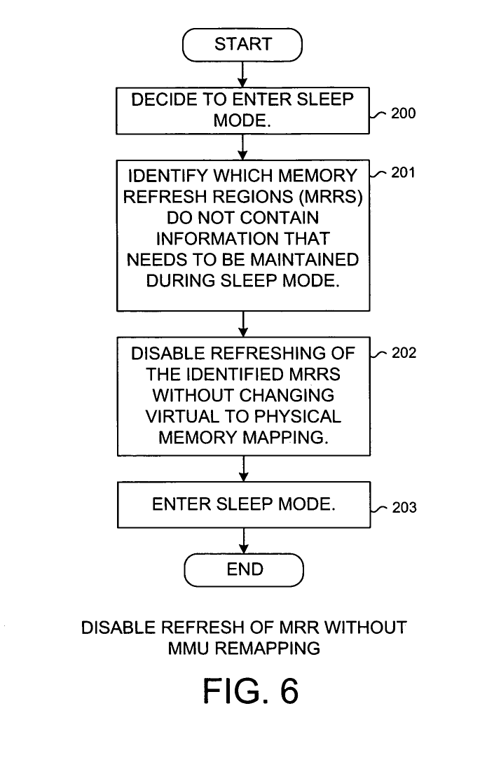

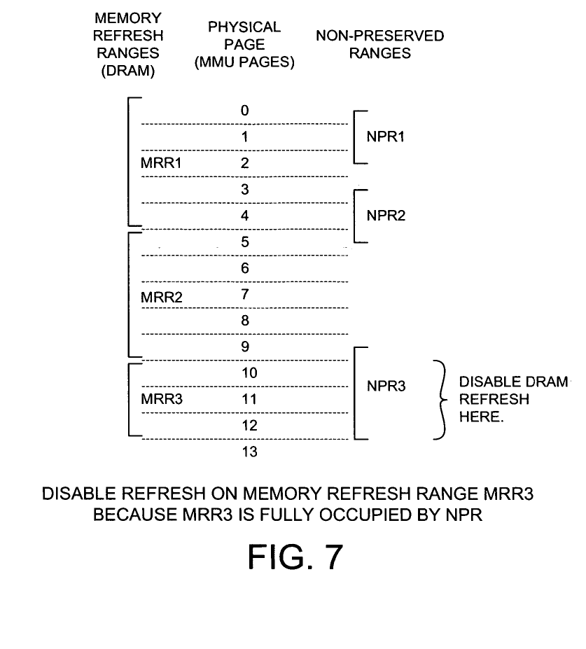

FIG. 6 is a flowchart of a first novel method of operation of the mobile communication device 1 of FIG. 1 wherein refreshing of an MRR is disabled, thereby saving power that would otherwise be consumed refreshing the MRR. FIG. 7 is a diagram that illustrates the contents and organization of memory in the first method.

In a first step (step 200 in FIG. 6), a decision is made that mobile communication device 1 is to enter a low power sleep mode. This decision may, for example, be made by sleep manager 2 in response to user input (such as, for example, due to the user's pressing a power off key).

In a second step (step 201), memory refresh ranges (MRRs) are identified that do not contain information that needs to be maintained during sleep mode. Memory refresh manger 3 may, for example, become aware of these MRRs due to heap manager 4 reporting ranges of heap virtual memory space that will not be allocated by the heap manager 4 in upcoming sleep mode operation. Similarly, task manager 5 may report ranges of stack virtual memory space that will not used by stacks in the upcoming sleep mode operation. Memory refresh manager 3 maintains knowledge of which virtual memory spaces are mapped to which physical memory pages (MPs), and which physical memory pages (MPs) are disposed in which physical memory refresh regions (MRRs) of DRAM. From the information received from heap manager 4 and task manager 5, and from knowledge of which virtual memory space ranges are mapped to which MRRs, memory refresh manager 3 identifies any MRRs that do not contain information that needs to be maintained during the sleep mode. (Although the identification of MRRs of step 201 is described here as occurring after the decision of step 200 is made to enter sleep mode, the order of the two steps can be reversed. Alternatively, the identification of MRRs of step 201 can be a continuously ongoing process.)

In the example of FIG. 7, ranges of virtual addresses NPR1, NPR2 and NPR3 are ranges of virtual address space, the contents of which do not need to be retained during sleep mode. These ranges NPR1, NPR2 and NPR3 are reported by heap manager 4 and task manager 5 to memory refresh manager 3. Memory refresh manager 3 determines that MRR3 is only mapped to non-preserved ranges (NPR3 in this case) and that MMR3 contains no information that needs to be maintained during the sleep mode.

Next (step 202), memory refresh manager 3 disables refreshing of the identified physical MRRs so that these MRRs are not refreshed during the subsequent sleep mode operation. In one example, memory refresh manager 3 disables refreshing of these MRRs by writing appropriate control information into the memory controller (MC) 8 of memory system 7. The control information includes a refresh enable command as well as an indication of the MRRs that need to be refreshed. By omitting from the control information the indications of the MRRs that do not need to be refreshed during sleep mode operation, subsequent operation of MC 8 does not involve refreshing of these MRRs. In this first novel method, memory refresh manager 3 does not change the virtual memory space to physical memory space mapping stored by MMU 6. In this example, application layer software operation is not disabled. MRRs that will not store information that needs to be retained during sleep mode operation are simply identified and refreshing of those MRRs is disabled by writing appropriate control information to memory controller 8. In the example of FIG. 7, MRR3 contains no information that must be retained during sleep mode operation. Memory refresh manager 3 therefore controls memory controller 8 to disable refreshing of MRR3.

Next (step 203), mobile communication device 1 enters sleep mode. In the example of FIG. 7, when mobile communication device 1 is operating in sleep mode MRR3 is not refreshed. As a result, power consumption is reduced in comparison to a system where unused DRAM is refreshed during sleep mode operation.

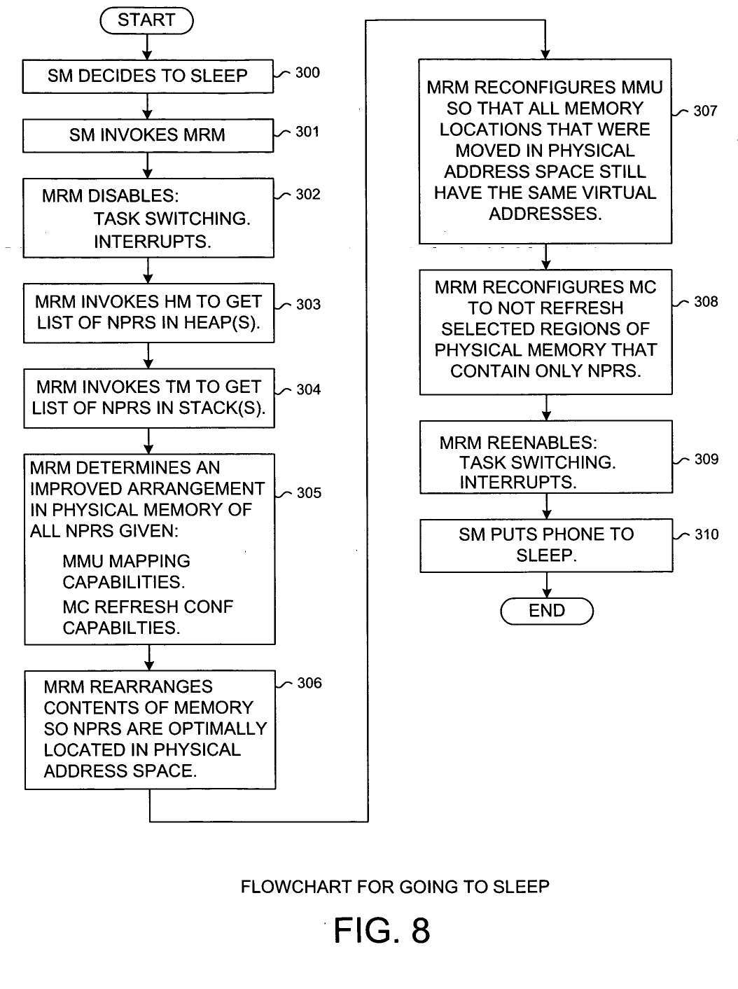

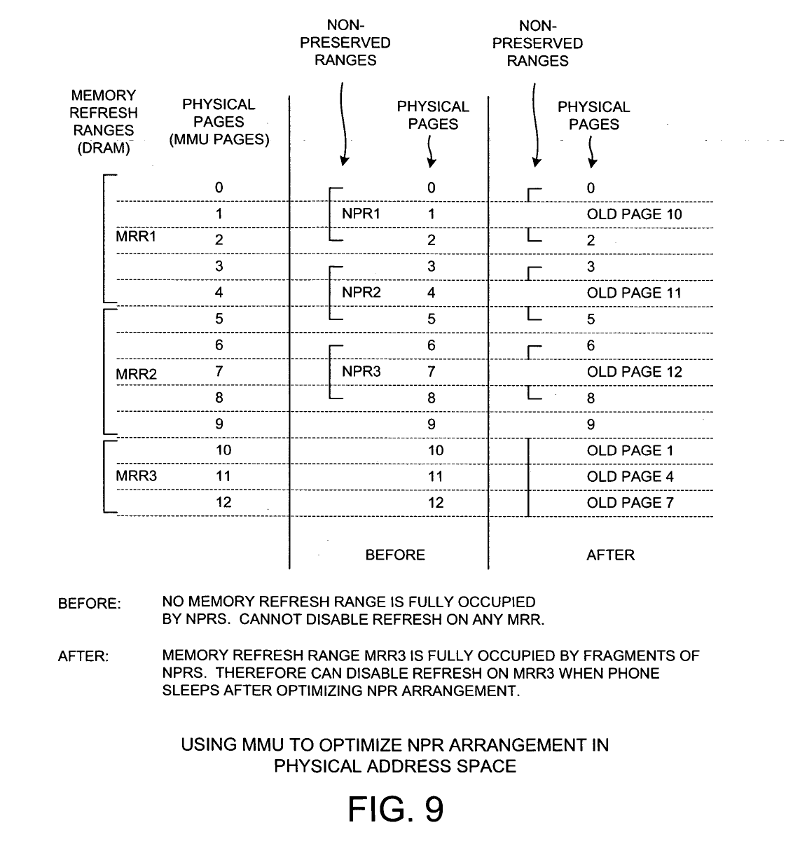

FIG. 8 is a flowchart of a second novel method of operation of mobile communication device 1 of FIG. 1. FIG. 9 is a diagram that illustrates the contents and organization of memory in the second method. In a first step (step 300 in FIG. 8), a decision is made that mobile communication device 1 is to enter a low power sleep mode. This decision may, for example, be made by sleep manager 2 in response to user input (such as, for example, due to the user's pressing a power off key).

In a second step (step 301), sleep manager 2 invokes MRM 3. MRM 3 responds by disabling task switching and by disabling interrupts (step 302). This disabling is performed so that software that is using memory space that is to be remapped will not be affected during the subsequent remapping process.

Next (step 303), MRM 3 invokes heap manager (HM) 4 and obtains from the heap manager 4 a list of virtual memory ranges in stack memory space, where each virtual memory range is a range of memory spaces that does not need to be refreshed during sleep mode. Heap manager 4 may, for example, designate a predetermined amount of heap memory 10 as being memory that will not be refreshed during sleep mode. This predetermined amount of heap memory 10 may be empirically determined by keeping track of the amount of heap that is not used during multiple periods of sleep mode operation.

Next (step 304), MRM 3 invokes task manager (TM) 5 and obtains from task manager 5 a list of virtual memory ranges in stack memory space, where each virtual memory range is a range of memory spaces that will not be used by any stack during sleep mode. Task manager 5 may identify these ranges empirically by keeping track of how deep in the various stacks values were pushed during multiple periods of sleep mode operation. Although one order of invoking the heap manager and task manager to obtain these virtual memory ranges is shown in the flowchart of FIG. 8, the heap and task managers can be invoked in the other order as well. Alternatively, all information about which areas of virtual address space will not be used during sleep mode may be obtained from either the heap manager or the task manager.

In step 305 of FIG. 8, MRM 3 determines an arrangement that would place the non-preserved ranges (NPRs) in physical memory adjacent to one another, such that entire memory refresh ranges (MRRs) of DRAM contain only NPRs. This arrangement maximizes or substantially maximizes the total amount of MRRs within DRAM that contain only NPRs.

FIG. 9 shows the arrangement of NPRs and physical pages before and after step 306 of FIG. 8. The leftmost two columns show how MRRs are organized in physical memory. The first column shows physical memory space realized entirely in DRAM, with the DRAM divided into three different memory refresh ranges (MRRs). The second column shows how memory is organized into physical memory pages (MPs). Physical MPs 0-4 are in MRR1. Physical MPs 5-9 are in MRR2. Physical MPs 10-12 are in MRR3.

The third and fourth columns in FIG. 9 show the non-preserved ranges (NPRs) and their corresponding physical memory pages (MPs) before step 306 of FIG. 8. The third column shows the NPRs that heap manager 4 and task manager 5 marked as not needing refresh during sleep mode. The fourth column shows the physical memory pages that the corresponding NPRs occupy. Memory space extends downward in the figure so that the page numbers increase from top to bottom of the figure (0-12 in this example). In the third column (which shows the MPs and NPRs before step 306), NPR1 includes part of MP 0, all of MP 1, and part of MP 2. NPR2 includes part of MP 3, all of MP 4, and part of MP 5. NPR3 includes part of MP 6, all of MP 7, and part of MP 8. As the BEFORE columns 3 and 4 of FIG. 9 show, each MMR (MRR1, MRR2 and MRR3) contains at least some information that must be preserved during sleep mode; therefore, refresh cannot be disabled on any of the MMRs during sleep mode unless the NPRs are rearranged.

The rightmost two columns in FIG. 9 show the result of rearranging memory after step 306 of FIG. 8 is complete (the arrangement was determined in step 305). In this new mapping, MP 10 (denoted as “OLD PAGE 10” under the “PHYSICAL PAGES” column 6 of FIG. 9) is copied to MP 1 (denoted as numeral “1” under “PHYSICAL PAGES” columns 2 and 4 and in the same row as “OLD PAGE 10”). Similarly, MP 11 is copied to MP 4, and MP 12 is copied to MP 7. All three copied pages 10, 11, 12 require refresh during sleep mode, since they did not reside within the non-preserved ranges NPR1, NPR2, or NPR3. Old MP 1, which contains information that need not be preserved during sleep mode, is copied to MP 10 (denoted as “OLD PAGE 1” under the “PHYSICAL PAGES” column 6). Likewise, old MP 4 and old MP 7, which also do not need to be preserved, are copied to MPs 11 and 12, respectively (denoted as “OLD PAGE 4” and “OLD PAGE 7” in column 6). In the new arrangement, note that MP 1, MP 4, and MP 7 all contain information that need not be preserved during sleep mode, and these pages are all mapped into a single memory management region 3 (MMR3), which contains no pages that require preservation; thus, MMR3 is now a candidate for disabling memory refresh and conserving power during subsequent sleep mode operation.

If the new arrangement were implemented without remapping virtual to physical memory addresses, then the software could no longer use the same virtual addresses to access information stored in the physical MPs that were moved during step 306. The virtual addresses would now be mapped to other physical memory pages, and software that relied on virtual addresses would not work correctly. Hence, the need for the memory remapping step 307 of FIG. 8.

In step 307 of FIG. 8, MRM 3 configures MMU 6 so that all memory locations that were moved in physical address space will have the same virtual addresses they had before step 306 (this step is not shown in FIG. 9). Step 307 ensures that the software continues to work properly without requiring changes to the software itself. Once step 307 is complete, the software remains unaware of changes to the physical memory arrangement determined in step 305 and performed in step 306, and it can retrieve information from the same virtual addresses as it did before physical memory was rearranged.

In step 308 of FIG. 8, MRM 3 reconfigures the memory controller 7 to disable refresh of MRRs that contain non-preserved regions (NPRs) only. In FIG. 9, only MRR3 can have refresh disabled because it is the only MRR that consists solely of NPRs (as indicated by the vertical lines next to “OLD PAGE 1”, “OLD PAGE 4”, and “OLD PAGE 7” in the fifth column of FIG. 9).

Next (step 308), MRM 3 reconfigures the memory controller 7 so that refreshing of MRRs that only contain NPRs is disabled. In the example of FIG. 9, MRR3 is only mapped to fragments of non-preserved ranges. This is indicated by the vertical lines in the second rightmost column of FIG. 9 in the rows that correspond to MRR3. Step 308 involves disabling the refreshing of MRR3.

Next (step 309), MRM 3 enables task switching and interrupts (step 309) so that application layer programs can run again and can be allocated sections of heap and can use stacks. Sleep manager 2 then puts mobile communication device 1 into sleep mode (step 310). When mobile communication device 1 is in sleep mode, the DRAM of MRR3 is not used by software and is not refreshed.

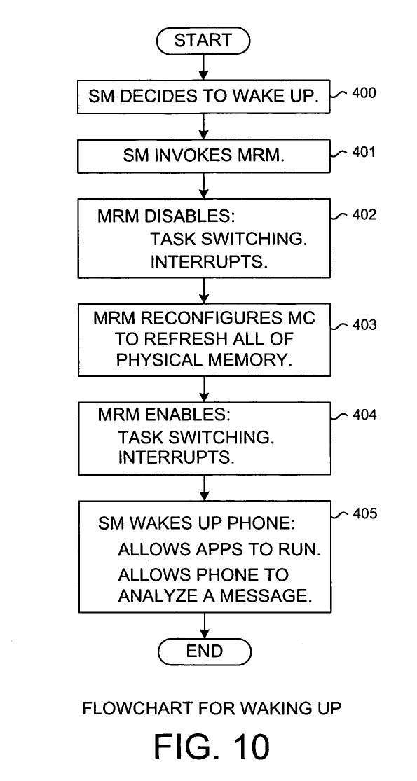

FIG. 10 is a flowchart of a third novel method wherein mobile communication device 1 wakes up after a period of sleep mode operation. Sleep manager 2 decides (step 400) that mobile communication device 1 is to recover from sleep mode operation and is to return to normal operating mode operation. Sleep manager 2 invokes MRM 3 (step 401). MRM 3 disables task switching and interrupts (step 402) so that a subsequent reconfiguring of memory controller 8 will not compromise the operation of application layer programs and tasks. MRM 3 then reconfigures the memory controller 8 so that all MRRs are refreshed (step 403). In the example of FIG. 9, the refreshing of MRR3 is again enabled, thereby reversing the refresh disabling of step 308 of FIG. 8. Memory controller 8 resumes refreshing MRR1, MRR2 and MRR3. Next (step 404), MRM 3 enables task switching and interrupts. Sleep manager 2 then causes mobile communication device 1 to exit sleep mode operation and the start operation in normal operation mode (step 405). Application layer programs are allowed to run. Where mobile communication device 1 is a cellular telephone, application layer programs are operable to analyze incoming cellular telephone messages and to perform other functions such as operation as a digital camera. All heap memory space 10 and all stack memory space 11 realized in DRAM is available for use.

Although certain specific embodiments are described above for instructional purposes, the present invention is not limited thereto. Accordingly, various modifications, adaptations, and combinations of the various features of the described specific embodiments can be practiced without departing from the scope of the invention as set forth in the claims.

What is claimed is:

1. A method, comprising:
(a) storing information in a memory system of a mobile communication device, the memory system comprising a plurality of memory refresh regions (MRRs), wherein refreshing of a particular MRR can be disabled independently of a refreshing of others of the MRRs, wherein the memory system is organized as a plurality of physical memory pages (MPs);
(b) maintaining a virtual to physical address translation such that each one of a plurality of virtual address ranges is mapped to a corresponding one of the plurality of physical memory pages (MPs);
(c) maintaining information on which ones of a plurality of the MPs store information that needs to be maintained in a sleep mode and which ones of the plurality of MPs do not store information that needs to be maintained when in the sleep mode, wherein a first of the MPs stores information that does not need to be maintained, wherein a second of the MPs does store information that needs to be maintained, wherein a third of the MPs does not store information that needs to be maintained, wherein the second and third MPs are adjacent pages in the memory system, wherein the first MP is a part of a first of said MRRs, and wherein the second and third MPs are parts of a second of said MRRs;
(d) copying information from the second MP to the first MP;
(e) changing the virtual to physical address translation such that the virtual address range that previously was mapped to the second MP is now mapped to the first MP, and such that the virtual address range that was previously mapped to the first MP is now mapped to the second MP; and
(f) configuring the memory system so that said first MRR is refreshed in the sleep mode but so that said second MRR is not refreshed in the sleep mode.

2. The method of claim 1, wherein the mobile communication system is a cellular telephone, wherein the memory refresh regions (MRRs) are regions of dynamic random access memory (DRAM).

3. The method of claim 2, wherein step (c) further comprises:
receiving an indication of a portion of heap memory from a heap manager, wherein the heap manager manages the heap, and wherein the portion of the heap is a portion that will not be used during the sleep mode.

4. The method of claim 2, wherein step (c) further comprises:
receiving an indication of a portion of a stack memory from a task manager, wherein the portion of the stack memory is a portion that will not be a part of any stack during the sleep mode.

5. The method of claim 2, wherein execution of application layer programs on the mobile communication device is disabled during said changing of the virtual to physical address translation in step (e).

6. The method of claim 2, wherein the memory system comprises a memory controller and an amount of dynamic random access memory (DRAM), wherein the configuring in (f) involves configuring the memory controller.

7. The method of claim 2, wherein some of the physical memory pages are DRAM, and wherein others of the physical memory pages are another type of memory.

8. The method of claim 2, wherein information that needs to be maintained in the sleep mode includes information that will not be accessed during the sleep mode, but rather may be accessed after sleep mode operation.

9. The method of claim 2, wherein the information on which ones of the plurality of the MPs store information that needs to be maintained in a sleep mode in step (c) includes: 1) a list of virtual memory address ranges, wherein each virtual memory address range in the list is a range of virtual memory addresses that does not need to be maintained in the sleep mode, 2) virtual memory address range to physical memory page translation information, and 3) information on the physical memory pages that correspond to each MRR.

10. A method comprising:
(a) storing information in dynamic random access memory (DRAM) in a mobile communication device, the DRAM comprising a plurality of memory refresh ranges (MRRs), wherein a refreshing of each MRR can be enabled and disabled independently of a refreshing of each other MRR;
(b) using a memory management unit (MMU) on the mobile communication device to maintain a virtual to physical address space translation, wherein the translation associates each one of a plurality of physical memory pages with a corresponding one of a plurality of virtual memory pages;
(c) identifying particular virtual memory pages that will not be used during a low power mode of operation of the mobile communication device;
(d) reconfiguring the memory management unit to remap the virtual to physical address space translation such that at least some of the physical memory pages that are mapped to the particular virtual memory pages identified in step (c) are conglomerated to be adjacent one another in physical memory space, the conglomerated physical memory pages being all the physical memory pages in a first of the MRRs; and
(e) operating the mobile communication device in the low power mode such that the first MRR is not refreshed but such that others of the MRRs are refreshed.

11. The method of claim 10, wherein step (c) involves receiving a list of ranges of virtual memory space, wherein each range in the list is a range of virtual memory space that will not be used during the low power mode, and wherein step (c) further involves determining which virtual memory pages correspond to each of the ranges in the list.

12. The method of claim 10, wherein step (c) involves receiving a list of virtual memory pages, wherein each virtual memory page in the list is a virtual memory page that will not be used during the low power mode.

13. The method of claim 10, wherein step (d) involves remapping the virtual to physical address space translation such that said at least some physical memory pages that are mapped to the particular virtual memory pages identified in step (c) are conglomerated to be in the first of the MRRs so that there are no physical memory pages in the first MRR that will be used during the low power mode, and such that others of the physical memory pages that are mapped to the particular virtual memory pages identified in step (c) are conglomerated to be in a second of the MRRs so that there are no physical memory pages in the second MRR that will be used during the low power mode, and wherein neither the first MRR nor the second MRR is refreshed during said operating in the low power mode in step (e).

14. The method of claim 10, wherein the mobile communication device is a cellular telephone having a heap, wherein a first portion of the heap is identified in step (c) to be a portion of virtual address space that will not be used during the low power mode of operation of the mobile communication device, and wherein a second portion of the heap is a portion of virtual address space that is used during the low power mode of operation of step (e), and wherein both the first portion and second portion are mapped by the MMU to physical memory pages in dynamic random access memory (DRAM).

15. The method of claim 10, wherein the mobile communication device is a cellular telephone having a stack memory space, wherein a first portion of the stack memory space is identified in step (c) to be a portion of virtual address space that will not be used during the low power mode of operation of the mobile communication device, and wherein a second portion of the stack memory space is a portion of virtual address space that is used during the low power mode of operation of step (e), and wherein both the first portion and second portion are mapped by the MMU to physical memory pages in dynamic random access memory (DRAM).

16. A mobile communication device, comprising:
an amount of dynamic random access memory (DRAM), the DRAM comprising a plurality of memory refresh ranges (MRRs), wherein a refreshing of each MRR can be enabled and disabled independently of a refreshing of each other MRR;
a memory management unit (MMU) that maintains a virtual to physical address space translation, wherein the translation associates each one of a plurality of physical memory pages with a corresponding one of a plurality of virtual memory pages;
a processor that executes a set of processor-executable instructions, wherein the set of processor-executable instructions is for performing the steps of:
(a) identifying particular virtual memory pages that will not be used during a low power mode of operation of the mobile communication device;
(b) reconfiguring the MMU to remap the virtual to physical address space translation such that at least some of the physical memory pages that are mapped to the particular virtual memory pages identified in step (a) are conglomerated to be adjacent one another in physical memory space, the conglomerated physical memory pages being all the physical memory pages in a first of the MRRs; and
(c) operating the mobile communication device in the low power mode such that the first MRR is not refreshed but such that others of the MRRs are refreshed.

17. The mobile communication device of claim 16, wherein step (b) involves remapping a virtual memory page that is used in the operating in step (c), wherein the virtual memory page before the remapping of step (b) is mapped to a first physical memory page, wherein the virtual memory page after the remapping of step (b) is mapped to a second physical memory page, and wherein the set of processor-executable instructions is also for performing the step of:
(d) copying information stored in the first physical memory page to the second physical memory page, and wherein the copying is performed after step (a) and before step (c).

18. The mobile communication device of claim 17, wherein the second physical memory page is refreshed during operation in the low power mode in step (c).

19. A device, comprising:
an amount of dynamic random access memory (DRAM), the DRAM comprising a plurality of memory refresh ranges (MRRs), wherein a refreshing of each MRR can be independently enabled and disabled; and
means for remapping a virtual to physical address space translation such that portions of virtual memory space that will not be used during a subsequent period of relative device inactivity are mapped to physical memory space such all the virtual address space mapped to a set of MRRs is virtual address space that will not be used during the subsequent period, wherein the MRRs of the set are chosen by the means such that the sum of all the address spaces of the MRRs in the set is substantially maximized.

20. The device of claim 19, wherein the device is a cellular telephone, wherein the means comprises a processor, a memory management unit, and set of processor-executable instructions, wherein the means is also for:
operating the device in the subsequent period such that refreshing of each of the MRRs of the set is disabled, and such that refreshing of other MRRs is enabled.

21. A set of processor-executable instructions stored on a processor-readable medium, the set of processor-executable instructions being for performing the steps of:
(a) storing information in an amount of dynamic random access memory (DRAM) within a device, the DRAM comprising a plurality of memory refresh ranges (MRRs), wherein a refreshing of each MRR can be enabled and disabled independently of a refreshing of each other MRR;
(b) using a memory management unit (MMU) that maintains a virtual to physical address space translation, wherein the translation associates each one of a plurality of physical memory pages with a corresponding one of a plurality of virtual memory pages;
(c) identifying particular virtual memory pages that will not be used during a low power mode of operation of the device;
(d) reconfiguring the MMU to remap the virtual to physical address space translation such that at least some of the physical memory pages that are mapped to the particular virtual memory pages identified in step (c) are conglomerated to be adjacent one another in physical memory space, the conglomerated physical memory pages being all the physical memory pages in one of the MRRs; and
(e) operating the device in the low power mode such that said one MRR is not refreshed but such that others of the MRRs are refreshed.

22. The set of processor-executable instructions of claim 21, wherein step (d) involves remapping a virtual memory page that is used in the operating in step (e), wherein the virtual memory page before the remapping of step (d) is mapped to a first physical memory page, wherein the virtual memory page after the remapping of step (d) is mapped to a second physical memory page, and wherein the set of processor-executable instructions is also for performing the step of:
(f) copying information stored in the first physical memory page to the second physical memory page, and wherein the copying is performed after step (c) and before step (d).

23. The set of processor-executable instructions of claim 21, wherein the device is a mobile communication device.

24. The set of processor-executable instructions of claim 21, wherein the processor-executable instructions that perform steps (b) through (e) are processor-executable instructions of an operating system executable on the device.
